(19) United States
(12) Patent Application Publication
(10) Pub. No.: US 2018/0229852 A1
(43) Pub. Date: Aug. 16, 2018

(54) VEHICLE AND UAV REFUELING AND RECHARGING SYSTEM

(71) Applicant: International Business Machines Corporation, Armonk, NY (US)

(72) Inventors: Gregory J. Boss, Saginaw, MI (US); Jeremy R. Fox, Georgetown, TX (US); Andrew R. Jones, Round Rock, TX (US); Kevin C. McConnell, Austin, TX (US); John E. Moore, JR., Brownsburg, IN (US)

(21) Appl. No.: 15/434,411

(22) Filed: Feb. 16, 2017

(51) Int. Cl. B64D 37/00; B60L 11/18; B64C 39/02; B64F 1/00; G06Q 20/32; B67D 7/08; B67D 7/84

(52) U.S. Cl. CPC B64D 37/00; B60L 11/1816; B64C 39/024; B64F 1/00; B64C 2201/042; B67D 7/08; B67D 7/845; B60L 2200/10; G06Q 20/32

(57) ABSTRACT

A drone or UAV can use a mobile docking platform mounted to a vehicle to receive fuel. The fuel provided from the vehicle to the UAV. By using a mobile docking platform mounted to a mobile vehicle, the UAVs can fly for a larger period of time without having to return to a home or base for fuel and/or refuel when the UAV is not needed for a main task.

### BACKGROUND

The present invention relates to unmanned aerial vehicle (UAV) refueling and recharging, and more specifically to refueling and recharging a UAV from a vehicle.

Drones or UAVs are becoming a normal fixture in everyday life. Drones have limited battery life for flying or fuel that can be contained within the drone. Drones other than recreational drones, for example drones which are tasked with specific jobs by an employer, need to be in the air as much as possible to maintain a continuous revenue stream or to provide continuous monitoring of a location.

### SUMMARY

According to one embodiment of the present invention, a method of refueling an unmanned aerial vehicle using a moving vehicle is disclosed. The method comprising the steps of: an unmanned aerial vehicle computer determining fuel is needed; the unmanned aerial vehicle computer sending a query to a server computer for an available refuel docking platform on a moving vehicle; the unmanned aerial vehicle computer reserving an available refuel docking platform on the moving vehicle; the unmanned aerial vehicle computer receiving information regarding docking the unmanned aerial vehicle on the available refuel docking platform on the moving vehicle; the unmanned aerial vehicle computer instructing the unmanned aerial vehicle to fly to the moving vehicle with the reserved, available refuel docking platform; the unmanned aerial vehicle computer pairing the unmanned aerial vehicle with the refuel docking platform; the unmanned aerial vehicle computer monitoring refueling of the unmanned aerial vehicle from the moving vehicle; and the unmanned aerial vehicle computer unpairing the unmanned aerial vehicle from the refuel docking platform of the moving vehicle once the unmanned aerial vehicle has been refueled.

According to another embodiment of the present invention, a computer program product for refueling an unmanned aerial vehicle using a moving vehicle is disclosed. The computer program product comprising a computer comprising at least one processor, one or more memories, one or more computer readable storage media. The computer program product comprising a computer readable storage medium having program instructions embodied therewith. The program instructions executable by the computer to perform a method comprising: determining, by an unmanned aerial vehicle computer, fuel is needed; sending, by the unmanned aerial vehicle computer, a query to a server computer for an available refuel docking platform on a moving vehicle; reserving, by the unmanned aerial vehicle computer, an available refuel docking platform on the moving vehicle; receiving, by the unmanned aerial vehicle computer, information regarding docking the unmanned aerial vehicle on the available refuel docking platform on the moving vehicle; instructing, by the unmanned aerial vehicle computer, the unmanned aerial vehicle to fly to the moving vehicle with the reserved, available refuel docking platform; pairing, by the unmanned aerial vehicle computer, the unmanned aerial vehicle with the refuel docking platform; monitoring, by the unmanned aerial vehicle computer refueling of the unmanned aerial vehicle from the moving vehicle; and unpairing, by the unmanned aerial vehicle computer, the unmanned aerial vehicle from the refuel docking platform of the moving vehicle once the unmanned aerial vehicle has been refueled.

According to another embodiment of the present invention, a computer system product for refueling an unmanned aerial vehicle using a moving vehicle is disclosed. The computer system comprising a computer comprising at least one processor, one or more memories, one or more computer readable storage media having program instructions executable by the computer to perform the program instructions. The program instructions comprising: determining, by an unmanned aerial vehicle computer, fuel is needed; sending, by the unmanned aerial vehicle computer, a query to a server computer for an available refuel docking platform on a moving vehicle; reserving, by the unmanned aerial vehicle computer, an available refuel docking platform on the moving vehicle; receiving, by the unmanned aerial vehicle computer, information regarding docking the unmanned aerial vehicle on the available refuel docking platform on the moving vehicle; instructing, by the unmanned aerial vehicle computer, the unmanned aerial vehicle to fly to the moving vehicle with the reserved, available refuel docking platform; pairing, by the unmanned aerial vehicle computer, the unmanned aerial vehicle with the refuel docking platform; monitoring, by the unmanned aerial vehicle computer refueling of the unmanned aerial vehicle from the moving vehicle; and unpairing, by the unmanned aerial vehicle computer, the unmanned aerial vehicle from the refuel docking platform of the moving vehicle once the unmanned aerial vehicle has been refueled.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a diagram of a plurality of vehicles, both available and unavailable, in a location for refueling a UAV.

FIG. 3 shows a flow diagram of a method of refueling a UAV or drone using moving vehicles.

FIG. 4 depicts an exemplary diagram of a possible data processing environment in which illustrative embodiments may be implemented.

FIG. 5 shows an example of a possible refuel docking platform attached to a vehicle.

### DETAILED DESCRIPTION

In an embodiment of the present invention, a drone or UAV can use a mobile docking platform mounted to a vehicle to receive fuel. The fuel provided from the vehicle to the UAV may be, but is not limited to: electricity through recharging of a battery of the

UAV, fossil fuel, such as, but not limited to gasoline or diesel, a combination of fossil fuel and electricity, or some other substance, natural or derived to power the drone or UAV. By using a mobile docking platform mounted to a mobile vehicle, the UAVs can fly for a larger period of time without having to return to a home or base for fuel and/or refuel when the UAV is not needed for a main task. No additional equipment is needed by the UAV to refuel.

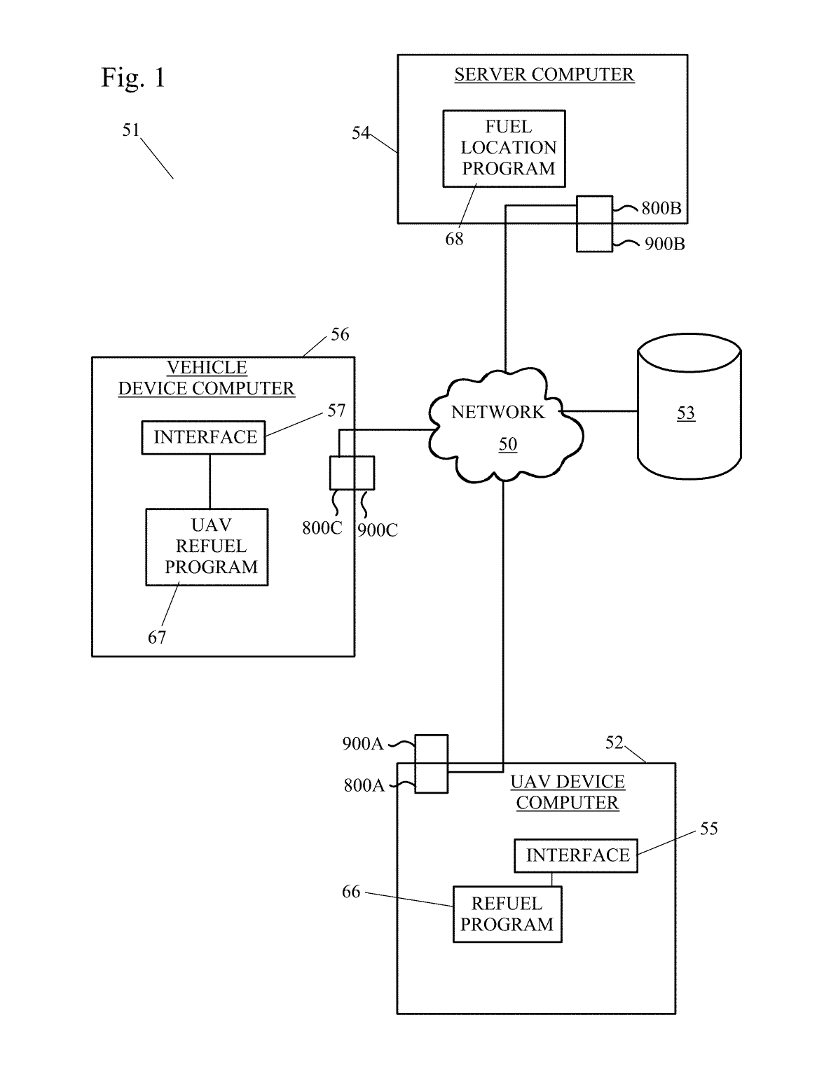

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, a drone or unmanned aerial vehicle (UAV) device computer 52, a vehicle device computer 56, a repository 53, and a server computer 54 connect to network 50. In other exemplary embodiments, network data processing system 51 may include additional client or device computers, storage devices or repositories, server computers, and other devices not shown.

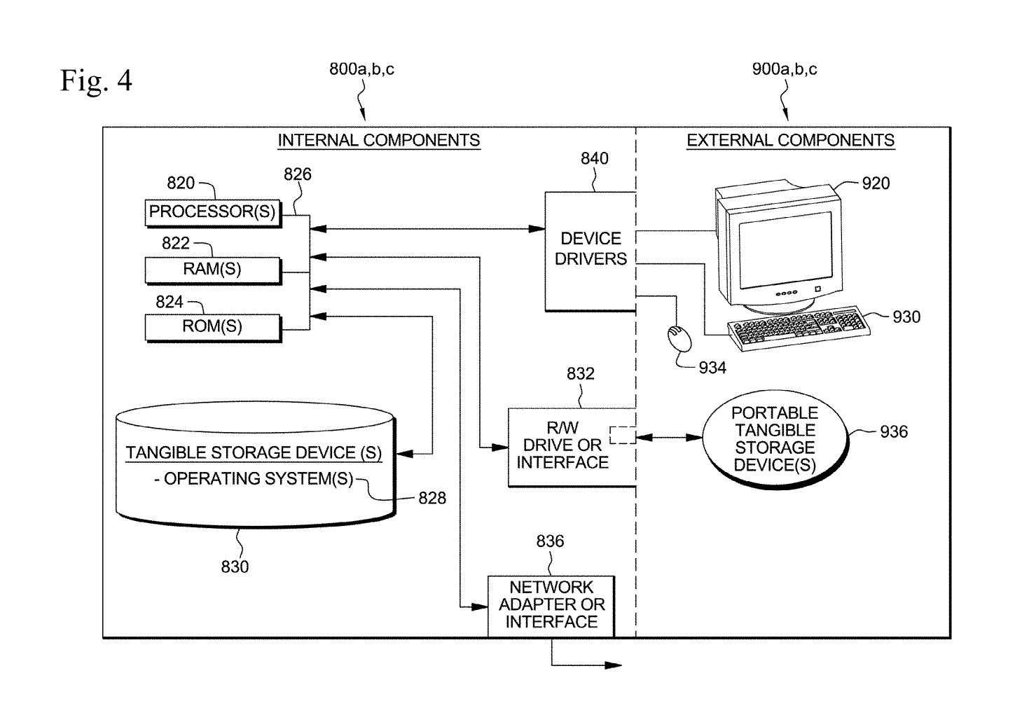

The UAV device computer 52 may contain an interface 55, which may accept commands and data entry from a user. The commands may be regarding destinations, tasks to perform, and locations to travel to. The interface 55 can be, for example, a command line interface, a graphical user interface (GUI), a natural user interface (NUI) or a touch user interface (TUI). The UAV device computer 52 preferably includes a refuel program 66. The refuel program 66 manages replenishing fuel, such as gasoline, and/or other energy sources, for example electricity, used to power the UAV or drone. The refuel program 66 can track remaining fuel available for use by the UAV and calculate a range associated with remaining fuel. The refuel program 66 can also query a server computer 54 to determine whether a moving vehicle is present within a travel range of the UAV on the remaining fuel and alter a set location of the UAV based on a determined location of a moving vehicle for refueling. The refuel program 66 can also manage docking the UAV on a non-stationary or moving vehicle to receive a replenishment of fuel. While not shown, it may be desirable to have the refuel program 66 be present on the server computer 54. The UAV device computer 52 includes a set of internal components 800a and a set of external components 900a, further illustrated in FIG. 4.

The vehicle device computer 56 may be a computer in any moving vehicle which provides adequate surface area to have a dock mounted thereon which can receive the UAV or UAV for fuel replenishment. The vehicle may be, but is not limited to a train, a monorail, a personal automobile, a truck or other vehicle. The vehicle device computer 56 may contain an interface 57, which may accept commands and data entry from a user. The commands may be regarding availability of removal of the vehicle's fuel with a UAV or drone, location of the vehicle, type of dock or fuel available or provided by the vehicle, speed of travel of the vehicle, destination of the vehicle, and other information relating to providing information for the UAV to locate and dock with the vehicle. The interface 57 can be, for example, a command line interface, a graphical user interface (GUI), a natural user interface (NUI) or a touch user interface (TUI). The vehicle device computer 56 preferably includes a UAV refuel program 67. The UAV refuel program 67 manages the fuel or recharge source availability of the vehicle for a UAV or drone. The UAV refuel program 67 may also communicate with the UAV device computer 52 to properly align and securely dock the UAV relative to the dock present on the vehicle. While not shown, it may be desirable to have the UAV refuel program 67 be present on the server computer 54. The vehicle device computer 56 includes a set of internal components 800c and a set of external components 900c, further illustrated in FIG. 4.

Server computer 54 includes a set of internal components 800b and a set of external components 900b illustrated in FIG. 4. In the depicted example, server computer 54 provides information, such as boot files, operating system images, and applications to the vehicle device computer 56 and the UAV device computer 52. The server computer 54 can provide such information as locations of the vehicles available to provide fuel replenishment to the UAV device computer 52. Server computer 54 can compute the information locally or extract the information from other computers on network 50. The server computer 54 may also contain a fuel location program 68 which manages the location of the vehicles which can provide replenishment of fuel to the UAVs and can convey the necessary information to the UAV device computers 52 to enable the UAVs to locate said vehicles.

Program code and programs such as UAV refuel program 67, fuel location program 68, or refuel program 66 may be stored on at least one of one or more computer-readable tangible storage devices 830 shown in FIG. 4, on at least one of one or more portable computer-readable tangible storage devices 936 as shown in FIG. 4, or on storage unit 53 connected to network 50, or may be downloaded to the vehicle device computer 56, the server computer 54 or the UAV device computer 52, for use. For example, program code and programs such as UAV refuel program 67 may be stored on at least one of one or more storage devices 830 on server computer 54 and downloaded to vehicle device computer 56 over network 50 for use. Additionally, programs such as the refuel program 66 may be stored on at least one of one or more storage devices 830 on server computer 54 and downloaded to UAV device computer 52 over network 50 for use. Alternatively, server computer 54 can be a web server, and the program code, and programs such as UAV refuel program 67 and refuel program 66, may be stored on at least one of the one or more storage devices 830 on server computer 54 and accessed by the vehicle device computer 56 or the UAV device computer 52. In other exemplary embodiments, the program code, and programs such as refuel program 66, UAV refuel program 67 and fuel location program 68 may be stored on at least one of one or more computer-readable storage devices 830 on vehicle device computer 56 or UAV device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

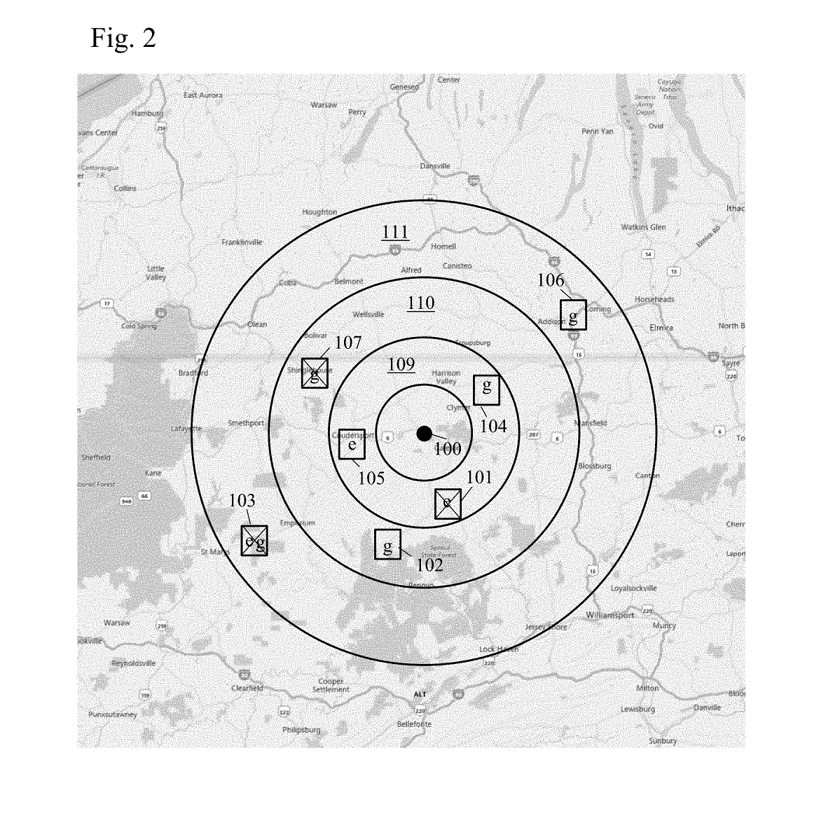

FIG. 2 shows a diagram of a plurality of vehicles, both available and unavailable, in a location for refueling a UAV.

UAV 100 has a limited amount of fuel left to carry out assigned tasks. The UAV 100 may query the server computer 54, for example through the refuel program 66, to determine a moving vehicle that can be used to replenish the fuel of the UAV 100. The replenishment may be completely refueling the UAV 100 or providing above a specific threshold of fuel which allows a specific percentage of the remaining tasks of the UAV 100 to be completed. Data regarding the remaining amount of fuel, travel range and current location may also be sent to the server computer 54 with the query. The server computer 54, for example through the fuel location program 68, can query vehicles which are present within a specific range of the UAV's location. Alternatively, locations of the vehicles which are available and their associated location may be fed to the server in real time and stored within a repository, for example repository 53, which the server computer 54 can query.

As shown in FIG. 2, there are numerous vehicles (indicated as boxes) available in different directions and mile ranges. Vehicles 101, 104 and 105 are present within five miles of the UAV 100 (first ring 109), vehicles 102 and 107 are present within ten miles of the UAV 100 (second ring 110), and vehicles 103 and 106 (third ring 111) are present within twenty-five miles of the UAV 100.

Vehicle 101 is unavailable for providing replenishment of fuel, either because it is currently being used by another UAV or because it does not have enough fuel to share with the UAV 100 as indicated by the “X” through the box. Vehicle 101 would not be offered to the UAV 100 as a refueling option. Similarly, vehicles 103 and 107 are also unavailable as indicated by the “X”. Even though vehicles are unavailable, the type of fuel which all of the vehicles carry is indicated in FIG. 2.

Vehicle 105 is available for providing replenishment of fuel through electric recharging as indicated by the “e”.

Vehicles 102, 104, 106, are also available and provide replenishment of fuel in the form of gasoline indicated by the “g”.

Based on the UAV's needs, i.e. electric recharging, the data regarding the location and docking with vehicle 105 would be sent to the UAV 100. The server computer 54 could remove vehicle 105 for providing further replenishment of fuel until the replenishment is complete between vehicle 105 and UAV 100.

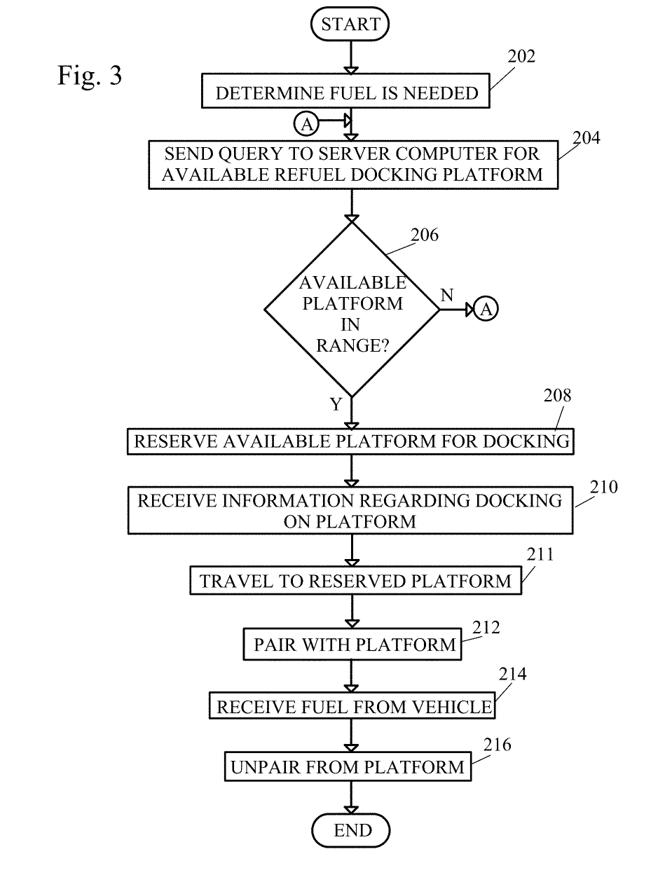

FIG. 3 shows a flow diagram of a method of refueling a UAV or drone using moving vehicles.

In a first step, a drone or UAV determines fuel is needed and range of flight available based on current fuel (step 202). The determination that fuel is needed by the UAV may be based on one of or a combination of: current fuel remaining, tasks left to complete, or time in between tasks remaining to complete. The range of flight available based on current fuel may be calculated for example using conventional methods.

The UAV sends a query to the server computer for an available refuel docking platform on a vehicle (step 204). The query may be sent via wireless Internet or cellular network. In alternate embodiment, the UAV can send a query out to any vehicles present within a range from the UAV.

In another alternate embodiment, the UAV can listen for a signal being sent by a vehicle with an available refuel docking platform. The signal sent by the vehicle to the UAV can be, but is not limited to via a wireless network, cellular network, ‘thin wire’ tether, long range BlueTooth®, or LEDs, which can be detected by a camera of the UAV. The signal can include, but is not limited to fuel available for the UAV or GPS coordinates of the platform attached to the vehicle.

If a refuel docking platform is available to provide fuel to the UAV (step 206), the UAV reserves the available refuel docking platform (step 208) to prevent other UAVs from pairing with the refuel docking platform. The reservation of a refuel docking program removes the refuel docking platform from being available for providing fuel to another UAV or drone within a set time period. In one embodiment, the reservation turns off a signal being sent out by the vehicle to UAVs in an area. Alternatively, the reservation removes the refuel docking platform from a database of available platforms accessible to the server computer.

The UAV receives information regarding docking the UAV with the refuel docking platform (step 210). The information preferably includes fuel available for the

UAV, coordinates of the platform location, destination of the vehicle, and route the vehicle is currently on.

The UAV travels to the reserved refuel docking platform (step 211) and the UAV pairs with the refuel docking platform on the moving vehicle (step 212).

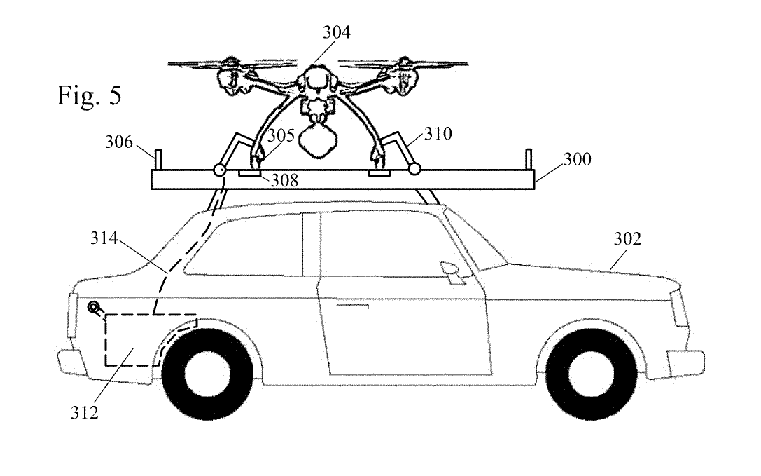

FIG. 5 shows an example of a platform 300 attached to a vehicle 302. It should be noted that the platform 300 does not need to be level, since the UAV 304 is secured to the platform 300. The refuel docking platform 300 may have sensors 306 which detect the presence of a UAV 304. The detection of the UAV 304 via the sensors 306 of the platform 300 turns on magnets 308 present on the platform 300 which align with skid pads 305 of a UAV 304. The magnets 308 may be strong enough to hold the UAV 304 in place. Once the sensors 306 detect the UAV 304 is in position, clamps 310 of the platform 304 can engage the skid pads 305 of the UAV 304. The platform 300 preferably supports landing or capture of the UAV 304 and takeoff or launch of the UAV 304 from the platform 304. The refueling system, which in this case includes the fuel tank 312 of the vehicle 302 preferably supports the refueling of multiple energy sources. Alternatively, a single refueling source can be provided. A line 314 is present to supply fuel from the fuel tank 312 of the vehicle 302 to the UAV 304.

The UAV receives fuel from the vehicle. The fuel is from the reserves associated with the vehicle (step 214). For example, electricity is provided from the electronics of the vehicle. In another example, fuel is provided from the vehicle's fuel tank 312.

Once the UAV is captured and locked in place on the platform, the UAV can recharge via inductions methods, via an induction charger present on a surface of the platform in contact with the UAV. Alternatively, the UAV can have a standard connector or plug which can be connected via a user.

The electric power that is provided to charge the UAV is preferably supplied from the vehicle's battery. It should be noted that before allowing the UAV to recharge, the vehicle's computer can verify that there is sufficient charge on the vehicle's battery to charge the UAV, such that the battery of the vehicle does not discharge to a point in which the vehicle cannot be started. For a fossil fuel powered UAV, a vehicle computer can determine fuel levels in the vehicle and if the fuel level is above a predetermined threshold (i.e. ¼th tank), fuel can be delivered to the UAV. The UAV preferably has an interface to accept fuel from the vehicle's fuel tank. This interface can be a receptacle for transferring the fossil fuels between tanks or a small pump on the UAV which can siphon fuel from the vehicle. Alternatively, a small pump can be present on the vehicle to pump the fuel from the vehicle to the UAV. A flow sensor can measure the amount of fuel transferred and shared with the vehicle computer system to allow for an exchange of payment between an owner of the UAV and the vehicle providing the fuel.

Once refueling is complete, the UAV unpairs from the refuel docking platform (step 216) and the method ends.

If a refueling docking platform is not available (step 206), the method returns to step 204.

It should be noted that for privately owned vehicles with platforms, permission may need to be obtained from the owner. This may be carried out securely using private and public keys which are exchanged between the UAV and the private owner of the platform. Payment may also be exchanged with the private owner of the platform.

Payment can additionally be exchanged between vehicles with platforms and owners of the UAVs. As part of the method, prior to the UAV unpairing from the refuel docking platform of step 216, but after receiving the fuel, the UAV can send data regarding the fuel received from the vehicle. The vehicle computer can communicate with the owner of the UAV to facilitate transfer of funds for the fuel.

FIG. 4 illustrates internal and external components of a vehicle device computer 56, a server computer 54, and a UAV device computer 52 in which illustrative embodiments may be implemented. In FIG. 4, vehicle device computer 56, a server computer 54, and a UAV device computer 52 include sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, UAV fuel program 67, refuel program 66, or fuel location program 68, are stored on one or more of the computer-readable tangible storage devices 830 for execution by one or more of the processors 820 via one or more of the RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. UAV fuel program 67, refuel program 66, and fuel location program 68 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. UAV fuel program 67, refuel program 66, and fuel location program 68 can be downloaded to the vehicle device computer 56, UAV device computer 52, and server computer 54 from an external computer via a network (for example, the Internet, a local area network or other, wide area network) and network adapter or interface 836. From the network adapter or interface 836, UAV fuel program 67, refuel program 66, and fuel location program 68 are loaded into hard drive 830. UAV fuel program 67, refuel program 66, and fuel location program 68 can be downloaded to the server computer 54 from an external computer via a network (for example, the Internet, a local area network or other, wide area network) and network adapter or interface 836. From the network adapter or interface 836, UAV fuel program 67, refuel program 66, and fuel location program 68 can be loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 934. Each of the sets of internal components 800a, 800b, 800c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

UAV fuel program 67, refuel program 66, and fuel location program 68 can be written in various programming languages including low-level, high-level, object-oriented or non object-oriented languages. Alternatively, the functions of a UAV fuel program 67, refuel program 66, and fuel location program 68 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory

(RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of refueling an unmanned aerial vehicle using a moving vehicle comprising the steps of:
an unmanned aerial vehicle computer determining fuel is needed;
the unmanned aerial vehicle computer sending a query to a server computer for an available refuel docking platform on a moving vehicle;
the unmanned aerial vehicle computer reserving an available refuel docking platform on the moving vehicle;
the unmanned aerial vehicle computer receiving information regarding docking the unmanned aerial vehicle on the available refuel docking platform on the moving vehicle;
the unmanned aerial vehicle computer instructing the unmanned aerial vehicle to fly to the moving vehicle with the reserved, available refuel docking platform;
the unmanned aerial vehicle computer pairing the unmanned aerial vehicle with the refuel docking platform;
the unmanned aerial vehicle computer monitoring refueling of the unmanned aerial vehicle from the moving vehicle; and
the unmanned aerial vehicle computer unpairing the unmanned aerial vehicle from the refuel docking platform of the moving vehicle once the unmanned aerial vehicle has been refueled.

2. The method of claim 1, wherein fuel provided to the unmanned aerial vehicle is from fuel used to power the moving vehicle.

3. The method of claim 1, wherein the query further comprises data regarding a remaining amount of fuel of the unmanned aerial vehicle, travel range of the unmanned aerial vehicle and current location of the unmanned aerial vehicle.

4. The method of claim 1, wherein the information regarding docking the unmanned aerial vehicle on the available refuel docking platform on the moving vehicle comprises: fuel available for refueling and coordinates of the platform in real time.

5. The method of claim 1, wherein the unmanned aerial vehicle is held in place using a magnet and clamps.

6. The method of claim 1, wherein the fuel provided from the moving vehicle to the unmanned aerial vehicle is selected from the group consisting of: fossil fuels and battery charging.

7. The method of claim 1, further comprising, prior to the unmanned aerial vehicle computer unpairing the unmanned aerial vehicle from the refuel docking platform of the moving vehicle once the unmanned aerial vehicle has been refueled, the unmanned aerial vehicle computer exchanging payment with an owner of the vehicle for fuel provided to the unmanned aerial vehicle from the moving vehicle.

8. A computer program product for refueling an unmanned aerial vehicle using a moving vehicle, a computer comprising at least one processor, one or more memories, one or more computer readable storage media, the computer program product comprising a computer readable storage medium having program instructions embodied therewith, the program instructions executable by the computer to perform a method comprising:
determining, by an unmanned aerial vehicle computer, fuel is needed;
sending, by the unmanned aerial vehicle computer, a query to a server computer for an available refuel docking platform on a moving vehicle;
reserving, by the unmanned aerial vehicle computer, an available refuel docking platform on the moving vehicle;
receiving, by the unmanned aerial vehicle computer, information regarding docking the unmanned aerial vehicle on the available refuel docking platform on the moving vehicle;
instructing, by the unmanned aerial vehicle computer, the unmanned aerial vehicle to fly to the moving vehicle with the reserved, available refuel docking platform;
pairing, by the unmanned aerial vehicle computer, the unmanned aerial vehicle with the refuel docking platform;
monitoring, by the unmanned aerial vehicle computer refueling of the unmanned aerial vehicle from the moving vehicle; and
unpairing, by the unmanned aerial vehicle computer, the unmanned aerial vehicle from the refuel docking platform of the moving vehicle once the unmanned aerial vehicle has been refueled.

9. The computer program product of claim 8, wherein fuel provided to the unmanned aerial vehicle is from fuel used to power the moving vehicle.

10. The computer program product of claim 8, wherein the query further comprises data regarding a remaining amount of fuel of the unmanned aerial vehicle, travel range of the unmanned aerial vehicle and current location of the unmanned aerial vehicle.

11. The computer program product of claim 8, wherein the information regarding docking the unmanned aerial vehicle on the available refuel docking platform on the moving vehicle comprises: fuel available for refueling and coordinates of the platform in real time.

12. The computer program product of claim 8, wherein the fuel provided from the moving vehicle to the unmanned aerial vehicle is selected from the group consisting of: fossil fuels and battery charging.

13. The computer program product of claim 8, further comprising, prior to the unmanned aerial vehicle computer unpairing the unmanned aerial vehicle from the refuel docking platform of the moving vehicle once the unmanned aerial vehicle has been refueled, exchanging, by the unmanned aerial vehicle computer, payment with an owner of the vehicle for fuel provided to the unmanned aerial vehicle from the moving vehicle.

14. A computer system for refueling an unmanned aerial vehicle using a moving vehicle, comprising a computer comprising at least one processor, one or more memories, one or more computer readable storage media having program instructions executable by the computer to perform the program instructions comprising:
determining, by an unmanned aerial vehicle computer, fuel is needed;
sending, by the unmanned aerial vehicle computer, a query to a server computer for an available refuel docking platform on a moving vehicle;
reserving, by the unmanned aerial vehicle computer, an available refuel docking platform on the moving vehicle;
receiving, by the unmanned aerial vehicle computer, information regarding docking the unmanned aerial vehicle on the available refuel docking platform on the moving vehicle;
instructing, by the unmanned aerial vehicle computer, the unmanned aerial vehicle to fly to the moving vehicle with the reserved, available refuel docking platform;
pairing, by the unmanned aerial vehicle computer, the unmanned aerial vehicle with the refuel docking platform;
monitoring, by the unmanned aerial vehicle computer refueling of the unmanned aerial vehicle from the moving vehicle; and
unpairing, by the unmanned aerial vehicle computer, the unmanned aerial vehicle from the refuel docking platform of the moving vehicle once the unmanned aerial vehicle has been refueled.

15. The computer system of claim 14, wherein fuel provided to the unmanned aerial vehicle is from fuel used to power the moving vehicle.

16. The computer system of claim 14, wherein the query further comprises data regarding a remaining amount of fuel of the unmanned aerial vehicle, travel range of the unmanned aerial vehicle and current location of the unmanned aerial vehicle.

17. The computer system of claim 14, wherein the information regarding docking the unmanned aerial vehicle on the available refuel docking platform on the moving vehicle comprises: fuel available for refueling and coordinates of the platform in real time.

18. The computer system of claim 14, wherein the fuel provided from the moving vehicle to the unmanned aerial vehicle is selected from the group consisting of: fossil fuels and battery charging.

19. The computer system of claim 14, further comprising, prior to the unmanned aerial vehicle computer unpairing the unmanned aerial vehicle from the refuel docking platform of the moving vehicle once the unmanned aerial vehicle has been refueled, exchanging, by the unmanned aerial vehicle computer, payment with an owner of the vehicle for fuel provided to the unmanned aerial vehicle from the moving vehicle.
